(19) United States
(12) Patent Application Publication
(10) Pub. No.: US 2026/0097733 A1
(43) Pub. Date: Apr. 9, 2026

(54) ADVANCED DRIVER ASSISTANCE SYSTEM SENSOR RETRACTABLE INLAY DOOR AND ENCLOSURE

(71) Applicant: FCA US LLC, Auburn Hills, MI (US)

(72) Inventors: Eric DeVito, Auburn Hills, MI (US); Reynante Buhat, Auburn Hills, MI (US)

(21) Appl. No.: 18/910,831

(22) Filed: Oct. 9, 2024

(51) Int. Cl. B60R 19/48; B60R 19/18

(52) U.S. Cl. CPC B60R 19/483; B60R 19/18; B60R 2019/1886

(57) ABSTRACT

A retractable inlay door and enclosure assembly includes a fascia, an inlay door cover, a first and second bracket, a radar and at least one bumper. The fascia defines an opening and includes engaging members configured thereon. The inlay door cover has at least one clip thereon configured to interface with an engaging member of the fascia in an installed position and release from the engaging member in an uninstalled position. A first bracket is coupled to the inlay door cover. A second bracket coupled to the first bracket. The radar is disposed between the first and second brackets. At least one bumper is positioned between the first and second brackets, constructed from a force-absorbing material. This design allows for relative movement of the first bracket toward the second bracket through the compression of the bumper.

### FIELD

The present application relates generally to advanced driver assistance systems (ADAS) and more particularly to a retractable inlay door and enclosure designed to house a radar assembly for enhanced ADAS functionality.

### BACKGROUND

Vehicles that incorporate ADAS typically include various long/short-range radar, light detection and ranging (LiDAR), ultrasonic sensing and cameras to facilitate safe driving. One common location to incorporate such sensors is within a vehicle fascia. These locations fall within impact zones of the vehicle where such devices are required to bounce back to their initial calibrated positions subsequent to an impact. As impact requirements for world markets differ, various low-impact standards must be satisfied for a vehicle to be sold in a specific country. It would be desirable to have a retractable inlay door/enclosure that housed such sensors that is adaptable to meet a variety of current and future safety standards across a wide range of countries. In other challenges, it can be difficult to aesthetically adopt such sensors for a plastic fascia. Further, in some arrangements it may be difficult to gain access to such sensors during service. Accordingly, while such radar assemblies for ADAS do work well for their intended purpose, there is a desire for improvement in the relevant art.

### SUMMARY

According to one example aspect of the invention, a retractable inlay door and enclosure assembly includes a fascia, an inlay door cover, a first and second bracket, a radar and at least one bumper. The fascia defines an opening and includes engaging members configured thereon. The inlay door cover has at least one clip thereon configured to interface with an engaging member of the fascia in an installed position and release from the engaging member in an uninstalled position. A first bracket is coupled to the inlay door cover. A second bracket coupled to the first bracket. The radar is disposed between the first and second brackets. At least one bumper is positioned between the first and second brackets, constructed from a force-absorbing material. This design allows for relative movement of the first bracket toward the second bracket through the compression of the bumper.

In other examples, the inlay door cover further comprises a snap feature including tabs that fixedly locate relative to complementary fingers extending from the first bracket.

In additional examples, the first bracket comprises a plurality of feet extending therefrom, wherein the plurality of feet are configured to engage and push against the at least one bumper.

In other implementations, the first bracket includes a plurality of elongated pins that locate into complementary slots formed in the second bracket.

In other examples, the plurality of elongated pins are configured to travel along the complementary slots during relative movement of the first bracket relative to the second bracket.

In other features, the first bracket includes snap fingers thereon that locate around snap ledges provided on the second bracket.

In other implementations, the engaging member of the fascia comprises: clip engaging members provided at a first side of the opening, the clip engaging members configured to (i) engage clips of the at least one clip on the inlay door cover in the installed position; and (ii) disengage the clips on the inlay door cover in the uninstalled position.

In still other examples, the engaging member of the fascia comprises: finger engaging members provided at a second side of the opening, opposite the first side, the finger engaging members configured to (i) engage fingers extending from the inlay door cover in the installed position and (ii) disengage the fingers on the inlay door cover in the uninstalled position.

In additional examples, the retractable inlay door and enclosure assembly further includes a pivot mechanism including a channel defined on the second bracket that locates a catch extending from the fascia, the catch interfacing along the channel during movement between the installed and uninstalled positions.

In other arrangements, the retractable inlay door and enclosure assembly further includes a knob extending from the second bracket, wherein the knob engages a ledge on the fascia during movement toward the uninstalled position to preclude overtravel of the second bracket.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a front perspective view of a retractable inlay door and enclosure assembly shown installed relative to a front fascia of an exemplary vehicle according to the principles of the present application;

FIG. 2 is an exploded front perspective view of the retractable inlay door and enclosure assembly of FIG. 1, the retractable inlay door and enclosure assembly including a cover, a radar assembly, a first or shroud bracket, a bumper assembly, a second or enclosure bracket and a fascia according to the principles of the present application;

FIG. 3 is a rear perspective view of the retractable inlay door and enclosure assembly of FIG. 1 according to the principles of the present application;

FIG. 4 is a front perspective view of the second bracket showing the radar assembly and bumper assembly installed relative thereto according to the principles of the present application;

FIG. 5 is a rear perspective view of the first bracket according to the principles of the present application;

FIG. 6A is a sectional view of the retractable inlay door and enclosure assembly shown in an installed and locked position according to the principles of the present application;

FIG. 6B is a sectional view of the retractable inlay door and enclosure assembly shown in an unlocked position according to the principles of the present application;

FIG. 6C is a sectional view of the retractable inlay door and enclosure assembly shown in an uninstalled position according to the principles of the present application; and

FIG. 7 is a partial perspective view of a pivot mechanism incorporated on the second bracket that interacts with the fascia according to examples of the present disclosure.

### DESCRIPTION

As discussed above, impact requirements for world markets differ and change over time. Various low-impact standards must be satisfied for a vehicle to be sold in a specific country. It would be desirable to have a retractable inlay door/enclosure that housed such ADAS sensors and that is adaptable for passing various safety standards for a wide range of countries. In other challenges, it can be difficult to aesthetically adopt such sensors for a plastic fascia. Further, in some arrangements it may be difficult to gain access to such sensors during service.

The present disclosure provides a retractable inlay door and enclosure assembly that houses a radar assembly and that is adaptable for a wide range of impact tests. Further, the retractable inlay door and enclosure assembly allows greater freedom in selecting materials when designing a fascia for either aesthetic or functional purposes. In particular, the retractable inlay door and enclosure assembly disclosed herein essentially decouples itself from the fascia allowing the use of any fascia material, any thickness and any paint without impacting the performance of the radar. It also reduces the risk of improper radar installation at the plant and minimizes or eliminates instances of radars becoming dislodged from their brackets during fascia installation. This helps prevent sensor misalignment, ensuring that ADAS features remain fully operational during the plant build process. In addition, the retractable inlay door and enclosure assembly allows for easier component serviceability. Explained further, a technician can easily access, service and/or replace the radar from the front of the fascia while keeping the fascia intact to the body of the vehicle.

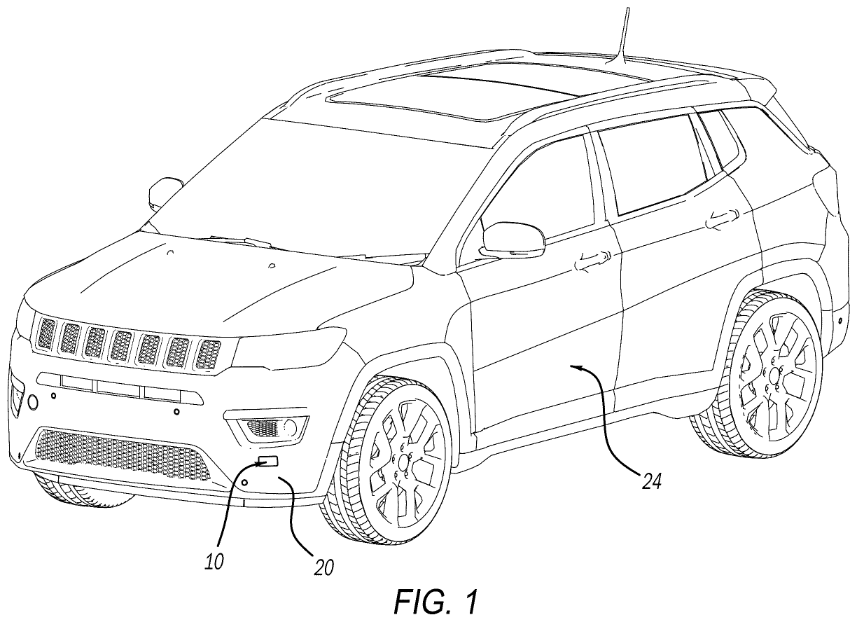

With initial reference to FIG. 1, a retractable inlay door and enclosure assembly is shown and generally identified at reference numeral 10. The retractable inlay door and enclosure assembly 10 includes and is shown installed relative to a fascia 20 of an exemplary vehicle 24. It will be appreciated that while the retractable inlay door and enclosure assembly 10 is shown incorporated at a driver's side front bumper, the retractable inlay door and enclosure assembly 10 can be configured at any area of any fascia, or other component, on the vehicle.

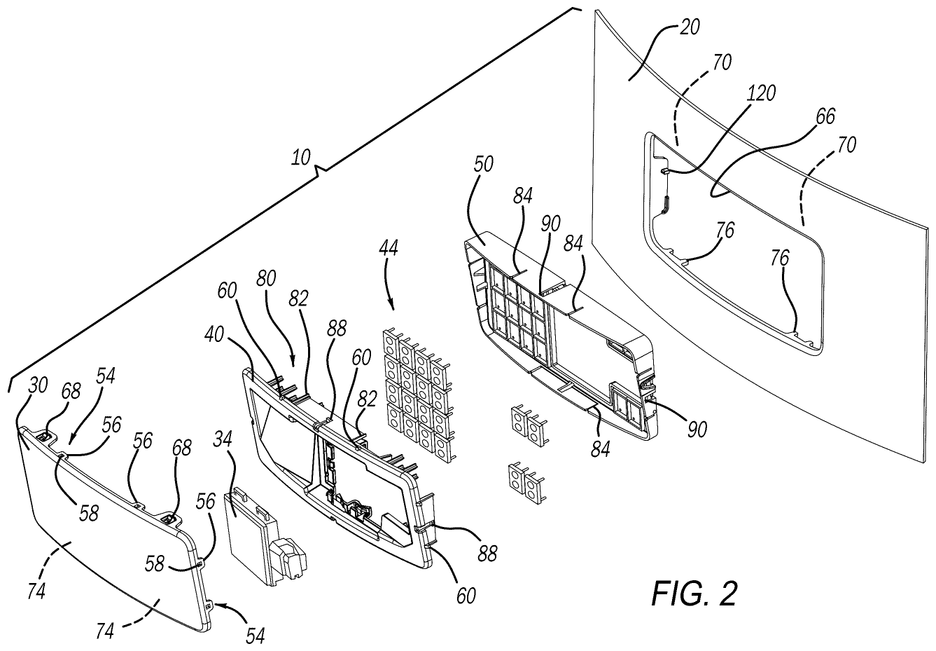

With additional reference now to FIGS. 2-7, additional features of the retractable inlay door and enclosure assembly 10 will be further described. The retractable inlay door and enclosure assembly 10 generally includes an inlay cover or door 30, a radar 34, a shroud or first bracket 40, a bumper assembly, collectively identified at reference 44, an enclosure bracket 50 and the fascia 20.

The inlay door 30 is dimensioned to extend beyond a field of view of the radar 34 and a package protect zone so as not to interfere with radar signals of the radar 34. The inlay door 30 is fixed to the first bracket 40 by way of a snap feature 54 that extends around a perimeter of the first bracket 40. In the example shown, the snap feature 54 includes tabs 56 having openings 58 that fixedly locate complementary fingers 60 extending from the first bracket 40. In this regard, in the event that the inlay door 30 were directly impacted, it would move the entire unit (inlay door 30 and the first bracket 40) back thus always maintaining the optimum distance between the radar surface and the B-side of the inlay door 30. This ensures that the vehicle radar calibrations remain unaltered.

Because the inlay door 30 is independent, materials can be selected with ideal radar attenuation properties and not be confined to the material of the fascia 20. Furthermore, molded in color materials can be selected thus avoiding the need for radar-to-paint evaluations (as each layer and type of paint color/primer/clearcoat further degrades the performance of the radar 34).

The inlay door 30 is a critical component to keeping the retractable inlay door and enclosure assembly 10 attached to the fascia 20. The retractable inlay door and enclosure assembly 10 is generally received at an opening 66 defined in the fascia 20. Clips 68 extend from an upper edge of the inlay door 30 that interface with complementary clip engaging members 70 that extend from the fascia 20. Similarly, fingers 74 extend from a lower edge of the inlay door 30 that interface with complementary finger engaging members 76 that extend from the fascia 20. In examples, the fascia 20 can be integrally molded with the clip engaging members 70 and the finger engaging members 76. In additional examples, the inlay door 30 can also support a heater element.

The first bracket 40 is fixed between the inlay door 30 and the second bracket 50. In particular, the first bracket 40 is not fixed (ultrasonically welded) to the fascia 20. The first bracket 40 snaps into the second bracket 50 by means of poka-yoke features 80 such that incorrect assembly is precluded. In examples, the poka-yoke features 80 include a plurality of elongated pins 82 formed on the first bracket 40 that locate into complementary slots 84 formed in the second bracket 50. Snap fingers 88 snap around snap ledges 90 provided on the second bracket 50. The pins 82, slots 84, snap fingers 88 and snap ledges 90 provide a travel stop that controls relative locations of the first and second brackets 40 and 50 to make sure they do not travel outside of an intended range.

The first bracket 40 maximizes radar performance and reduces angular error. In examples, the first bracket 40 can be formed of radar absorbing material (RAM) to minimize reflection and multibounce within the enclosure. Additionally weep hole(s) can be incorporated to allow water or condensation buildup to be removed from the unit to help maintain an ideal environment for the radar 34.

With particular reference to FIG. 5, the first bracket 40 includes a plurality of feet 94 extending therefrom. The feet 94 are configured to engage and push against the bumpers 44 press-fitted into the second bracket 50. In examples, the bumpers 44 are formed of force absorbing material such as elastomeric and/or silicone material. In the event of a force being applied to the cover 30, relative movement of the first bumper 40 toward the second bumper 50 is facilitated by compression of the bumpers 44. In this regard, once force is removed from the inlay door 30, the bumpers 44 within the second bracket 50 return to their original at-rest position thus moving the first bracket 40 back to its initial calibrated position.

In some examples, a linear solenoid can be provided that would ensure the inlay door 30 and the first bracket 40 gets urged back into the same position subsequent to an impact. In such examples, the radar 34 could have a dedicated pin with supporting software that when misaligned or out of position, it could send a signal to the solenoid for readjustment to match factory vehicle calibration settings (so that the inlay door 30 maintains a flush appearance with the fascia 20 from an outside perspective).

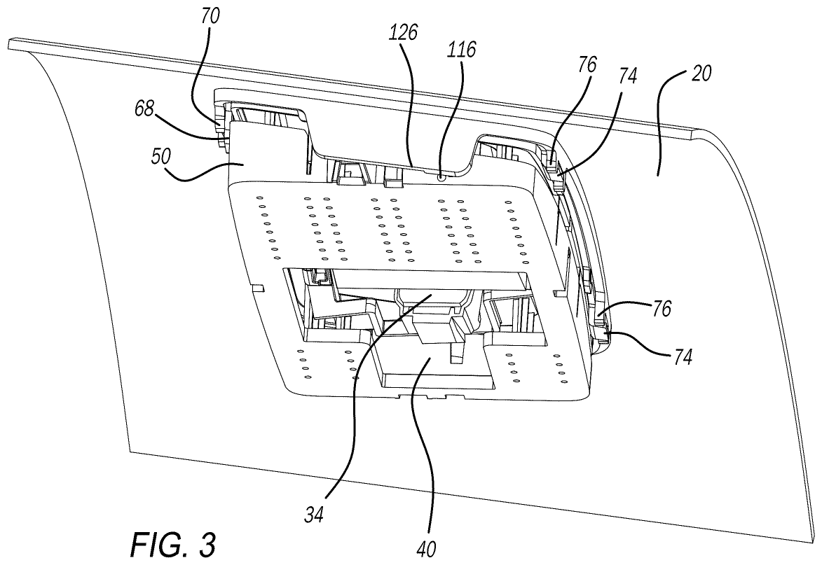

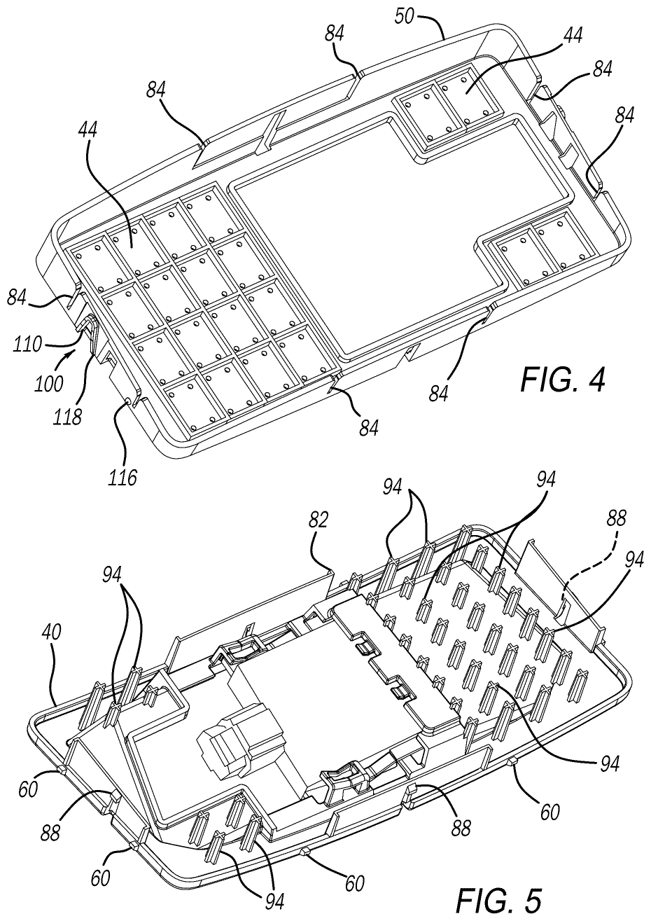

With particular reference to FIG. 4, additional features of the second bracket 50 will be further described. The second bracket 50 includes a pivot mechanism 100 that interacts with the fascia 20. The pivot mechanism 100 includes a channel 110 and a knob 116. The channel 110 includes a track 118 that generally locates relative to catch 120 (FIG. 2) that extends from the fascia 20. The knob 116 generally limits travel of the second bracket 50 by engaging a ledge 126 (FIG. 3) on the fascia 20 to preclude overtravel.

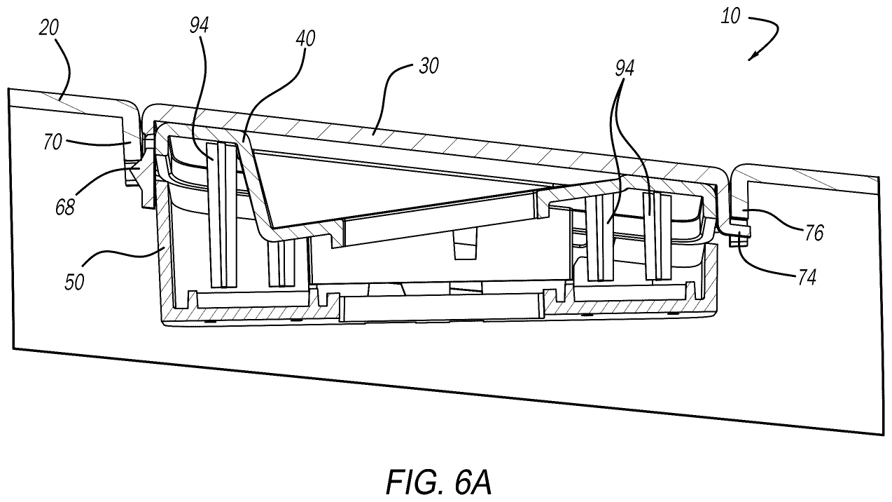

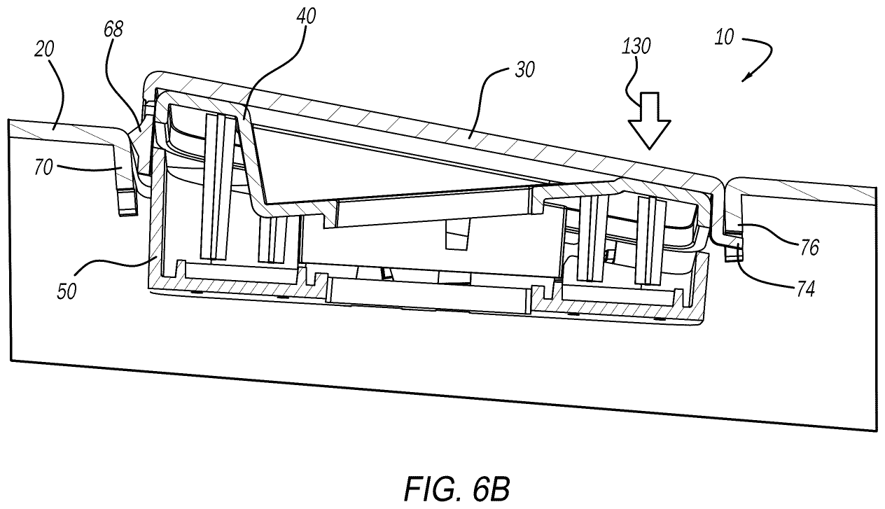

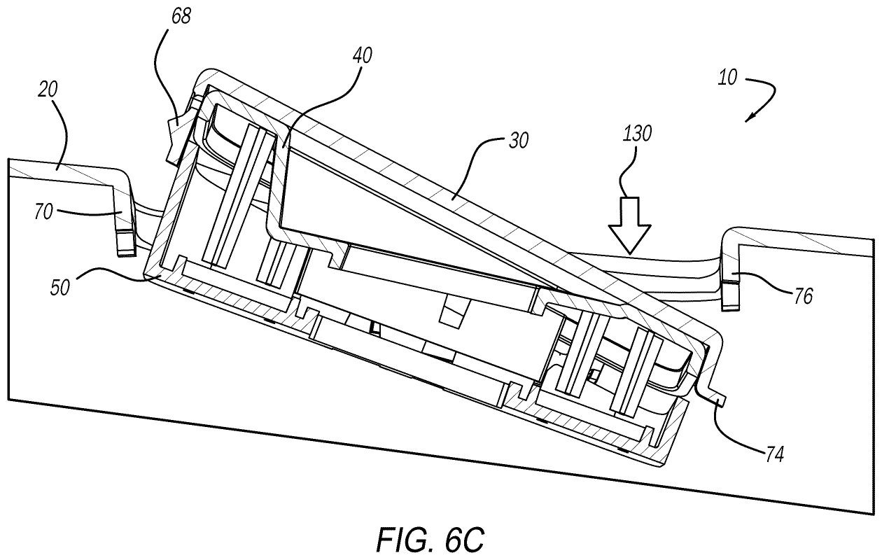

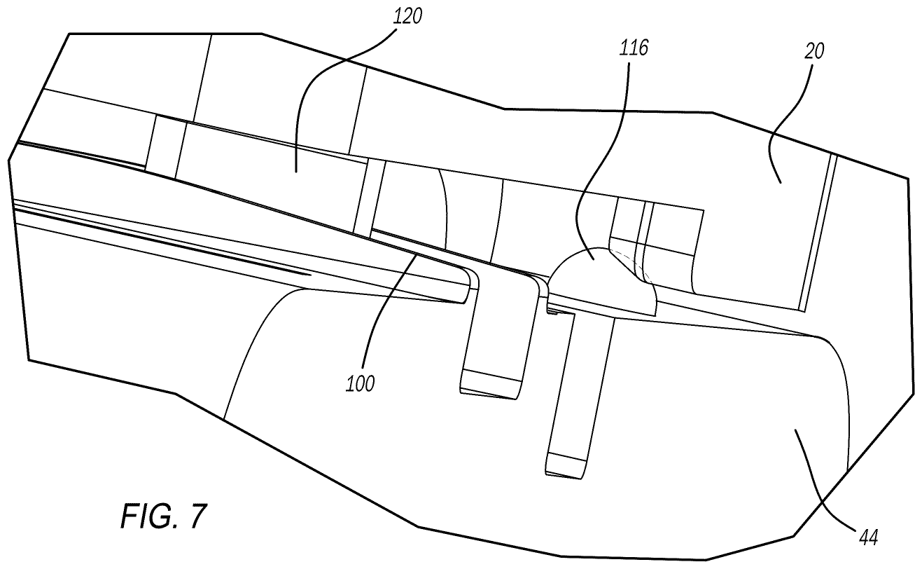

FIG. 6A is a sectional view of the retractable inlay door and enclosure assembly 10 shown in an installed and locked position. In the installed and locked position, the clips 68 of the inlay door 30 interface with complementary clip engaging members 70 that extend from the fascia 20 (see also FIG. 3). Similarly, the fingers 74 extending from a lower edge of the inlay door 30 interface with complementary finger engaging members 76 that extend from the fascia 20.

FIG. 6B is a sectional view of the retractable inlay door and enclosure assembly 10 shown in an unlocked position. In the unlocked position, the clips 68 of the inlay door 30 are displaced out of engagement with the complementary clip engaging members 70 that extend from the fascia 20. In examples, such action can be encouraged by pressing on the inlay door 30 such as at an area between the opposite end of the inlay door 30 proximate the fingers 74 (see arrow 130). The fingers 74 extending from a lower edge of the inlay door 30 remain engaged with complementary finger engaging members 76 that extend from the fascia 20 in the unlocked position.

FIG. 6C is a sectional view of the retractable inlay door and enclosure assembly 10 shown in an uninstalled position. In the uninstalled position, the clips 68 of the inlay door 30 are displaced further out of engagement with the complementary clip engaging members 70 that extend from the fascia 20. In examples, such action can be encouraged by pressing on the inlay door 30 such as at an area between the opposite end of the inlay door 30 proximate the fingers 74 (see arrow 130). The fingers 74 extending from a lower edge of the inlay door 30 are also displaced relative to the complementary finger engaging members 76 that extend from the fascia 20 in the uninstalled position.

From the uninstalled position, the inlay door 30 together with the first and second brackets 40, 50 and the radar 34 of the retractable inlay door and enclosure assembly 10 can be grasped and removed from the fascia 20. In particular, the track 118 of the pivot mechanism 100 can be pulled out of engagement from the catch 120 of the fascia allowing release of the assembly (inlay door 30, radar 34, first bracket 40, and second bracket 50) from the fascia 20.

During movement of the inlay door 30, radar 34, and first and second brackets 40, 50 from the locked to the unlocked and uninstalled positions, the catch 120 (FIGS. 2 and 7) that extends from the fascia 20 rides within the channel 110 provided on the second bracket 50. In this regard, the pivot mechanism 100 allows the second bracket 50 to travel relative to the fascia 20. Moreover, the knob 116 (FIG. 7) generally limits travel of the second bracket 50 by engaging a ledge 126 (FIG. 3) on the fascia 20 to preclude overtravel.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A retractable inlay door and enclosure assembly comprising:
a fascia defining an opening and including engaging members configured thereon;
an inlay door cover having at least one clip thereon configured to interface with an engaging member of the fascia in an installed position and release from the engaging member in an uninstalled position;
a first bracket coupled to the inlay door cover;
a second bracket coupled to the first bracket;
a radar disposed between the first and second brackets; and
at least one bumper disposed between the first and second brackets, the at least one bumper being formed of force absorbing material such that relative movement of the first bracket toward the second bracket is facilitated by compression of the at least one bumper.

2. The retractable inlay door and enclosure assembly of claim 1, wherein the inlay door cover further comprises a snap feature including tabs that fixedly locate relative to complementary fingers extending from the first bracket.

3. The retractable inlay door and enclosure assembly of claim 1, wherein the first bracket comprises a plurality of feet extending therefrom, wherein the plurality of feet are configured to engage and push against the at least one bumper.

4. The retractable inlay door and enclosure assembly of claim 1, wherein the first bracket includes a plurality of elongated pins that locate into complementary slots formed in the second bracket.

5. The retractable inlay door and enclosure assembly of claim 4, wherein the plurality of elongated pins are configured to travel along the complementary slots during relative movement of the first bracket relative to the second bracket.

6. The retractable inlay door and enclosure assembly of claim 4, wherein the first bracket includes snap fingers thereon that locate around snap ledges provided on the second bracket.

7. The retractable inlay door and enclosure assembly of claim 1, wherein the engaging member of the fascia comprises:
clip engaging members provided at a first side of the opening, the clip engaging members configured to (i) engage clips of the at least one clip on the inlay door cover in the installed position; and (ii) disengage the clips on the inlay door cover in the uninstalled position.

8. The retractable inlay door and enclosure assembly of claim 1, wherein the engaging member of the fascia comprises:
finger engaging members provided at a second side of the opening, opposite the first side, the finger engaging members configured to (i) engage fingers extending from the inlay door cover in the installed position and (ii) disengage the fingers on the inlay door cover in the uninstalled position.

9. The retractable inlay door and enclosure assembly of claim 1, further comprising:
a pivot mechanism including a channel defined on the second bracket that locates a catch extending from the fascia, the catch interfacing along the channel during movement between the installed and uninstalled positions.

10. The retractable inlay door and enclosure assembly of claim 9, further comprising a knob extending from the second bracket, wherein the knob engages a ledge on the fascia during movement toward the uninstalled position to preclude overtravel of the second bracket.
